(19) United States
(12) Patent Application Publication
(10) Pub. No.: US 2021/0051716 A1
(43) Pub. Date: Feb. 18, 2021

(54) Handling Persistently Occupied Channels within Unlicensed Radio Spectrum

(71) Applicant: Google LLC, Mountain View, CA (US)

(72) Inventors: Pavan Santhana Krishna Nuggehalli, San Carlos, CA (US); Shiang-Rung Ye, New Taipei City (TW)

(73) Assignee: Google LLC, Mountain View, CA (US)

(21) Appl. No.: 16/987,069

(22) Filed: Aug. 6, 2020

Related U.S. Application Data
(60) Provisional application No. 62/887,301, filed on Aug. 15, 2019.

(51) Int. Cl. H04W 74/08; H04W 16/14; H04W 24/04

(52) U.S. Cl. CPC H04W 74/0808; H04W 74/0833; H04W 24/04; H04W 16/14

(57) ABSTRACT

This document describes techniques and devices for identifying and handling persistently occupied channels within unlicensed radio spectrum. In particular, a user equipment (UE) determines whether or not a channel that is associated with a particular bandwidth part or a sub-band of the bandwidth part is persistently occupied. The UE employs techniques that decrease sensitivity to uplink transmission timing or short-term channel congestion and enables the UE to efficiently identify persistently occupied channels. For example, the UE can use a first timer and a first counter to determine whether or not the channel is persistently occupied. The UE can recover from a situation in which the channel is persistently occupied and report information to a base station regarding the persistently occupied channel. In this way, the UE can utilize the unlicensed radio spectrum and re-establish communications responsive to the presence of one or more persistently occupied channels.

### CROSS-REFERENCE TO RELATED APPLICATION

This application claims the benefit of U.S. Provisional Application No. 62/887,301 filed 15 Aug. 2019, the disclosure of which is hereby incorporated by reference in its entirety herein.

### BACKGROUND

Licensed radio spectrum is limited and monetarily costly. Some Fifth Generation New Radio (5G-NR) techniques offload cellular traffic from the licensed radio spectrum to unlicensed radio spectrum. To utilize the unlicensed radio spectrum, 5G-capable devices operate under regulations that require access techniques to fairly share the unlicensed radio spectrum with other users. In contrast to the more-tightly-managed access to resources of the licensed radio spectrum, operations under spectrum-sharing regulations for the unlicensed radio spectrum can create uncertainty about when particular resources will be available or become unavailable. Consequently, a 5G-capable device may not be able to transmit on a desired channel in a timely fashion if that channel is in use by another wireless transmitting device. Delays caused by these transmission rules can make it challenging to perform time-sensitive or periodic transmissions.

### SUMMARY

This document describes techniques and devices for identifying and handling persistently occupied channels within unlicensed radio spectrum. In particular, a clear-channel-assessment module of a user equipment (UE) determines whether or not a channel that is associated with a particular bandwidth part or a sub-band of the bandwidth part is persistently occupied. The clear-channel-assessment module employs techniques that decrease the clear-channel-assessment module's sensitivity to uplink transmission timing or short-term channel congestion and enables the clear-channel-assessment module to efficiently identify persistently occupied channels. Additionally, the clear-channel-assessment module determines whether or not multiple channels that are associated with different bandwidth parts or different sub-bands of a particular bandwidth part are persistently occupied. The clear-channel-assessment module enables the UE to recover from this situation and report information to a base station regarding the persistently occupied channels. In this way, the UE can utilize the unlicensed radio spectrum and re-establish communications responsive to the presence of one or more persistently occupied channels.

Aspects described below include a method performed by a user equipment for identifying persistently occupied channels within unlicensed radio spectrum. The method includes executing a first clear-channel-assessment procedure for a first channel. The method also includes determining that the first channel is occupied based on the first clear-channel-assessment procedure. Responsive to determining that the first channel is occupied, the method includes starting a first timer and initializing a first counter. The method includes executing subsequent clear-channel-assessment procedures for the first channel. The method also includes incrementing, within a duration of the first timer, the first counter to count a first quantity of the subsequent clear-channel-assessment procedures that determine that the first channel is occupied. Responsive to the first counter being greater than a first threshold, the method includes determining that the first channel is persistently occupied. The method may further include operations to handle a persistently occupied channel, when such a channel has been identified.

Aspects described below also include a user equipment with a radio-frequency transceiver. The user equipment also includes a processor and memory system configured to perform any of the methods described.

Aspects described below additionally include a processor-readable medium having instructions stored thereon that, when executed by a processor, cause the processor to perform any of the methods described.

Aspects described below further include a system with means for handling persistently occupied channels within unlicensed radio spectrum.

### BRIEF DESCRIPTION OF THE DRAWINGS

Apparatuses of and techniques for handling persistently occupied channels within unlicensed radio spectrum are described with reference to the following drawings. The same numbers are used throughout the drawings to reference like features and components:

FIG. 1 illustrates an example wireless network environment in which handling of persistently occupied channels within unlicensed radio spectrum can be implemented.

FIG. 2 illustrates an example user equipment for handling persistently occupied channels within unlicensed radio spectrum.

FIG. 3 illustrates an example method for detecting a persistently occupied channel within unlicensed radio spectrum using a first timer.

FIG. 4 illustrates an example method for detecting a persistently occupied channel within unlicensed radio spectrum using a first timer, a first counter, and a second counter.

FIG. 5 illustrates an example method for initiating a random-access procedure for detecting a persistently occupied channel within unlicensed radio spectrum.

FIG. 6 illustrates an example method for detecting a persistently occupied channel within unlicensed radio spectrum using a random-access procedure, a first timer, and a first counter.

FIG. 7 illustrates an example method for detecting a persistently occupied channel within unlicensed radio spectrum using a random-access procedure, a first timer, and a second timer.

FIG. 8 illustrates yet another example method for detecting a persistently occupied channel within unlicensed radio spectrum using a window-based detection scheme.

FIG. 9 illustrates an example method for recovering from multiple persistently occupied channels within unlicensed radio spectrum.

FIG. 10 illustrates an example method for handling persistently occupied channels within unlicensed radio spectrum.

### DETAILED DESCRIPTION

Overview

Licensed radio spectrum is limited and monetarily costly. Some Fifth Generation New Radio (5G-NR) techniques offload cellular traffic from the licensed radio spectrum to unlicensed radio spectrum. To utilize the unlicensed radio spectrum, 5G-capable devices operate under regulations that require access techniques to fairly share the unlicensed radio spectrum with other users. In contrast to the more-tightly-managed access to resources of the licensed radio spectrum, operations under spectrum-sharing regulations for the unlicensed radio spectrum can create uncertainty about when particular resources will be available or become unavailable. Consequently, a 5G-capable device may not be able to transmit on a desired channel in a timely fashion if that channel is in use by another wireless transmitting device. Delays caused by these transmission rules can make it challenging to perform time-sensitive or periodic transmissions.

To address this challenge, techniques and devices for handling persistently occupied channels within unlicensed radio spectrum are described. In particular, a clear-channel-assessment module of a user equipment (UE) determines whether or not a channel that is associated with a particular bandwidth part or a sub-band of the bandwidth part is persistently occupied. The clear-channel-assessment module employs techniques that decrease the clear-channel-assessment module's sensitivity to uplink transmission timing or short-term channel congestion and enables the clear-channel-assessment module to efficiently identify persistently occupied channels. Additionally, the clear-channel-assessment module determines whether or not multiple channels that are associated with different bandwidth parts or different sub-bands of a particular bandwidth part are persistently occupied. The clear-channel-assessment module enables the UE to recover from this situation and report information to a base station regarding the persistently occupied channels. In this way, the UE can utilize the unlicensed radio spectrum and re-establish communications responsive to the presence of one or more persistently occupied channels.

Example Environment

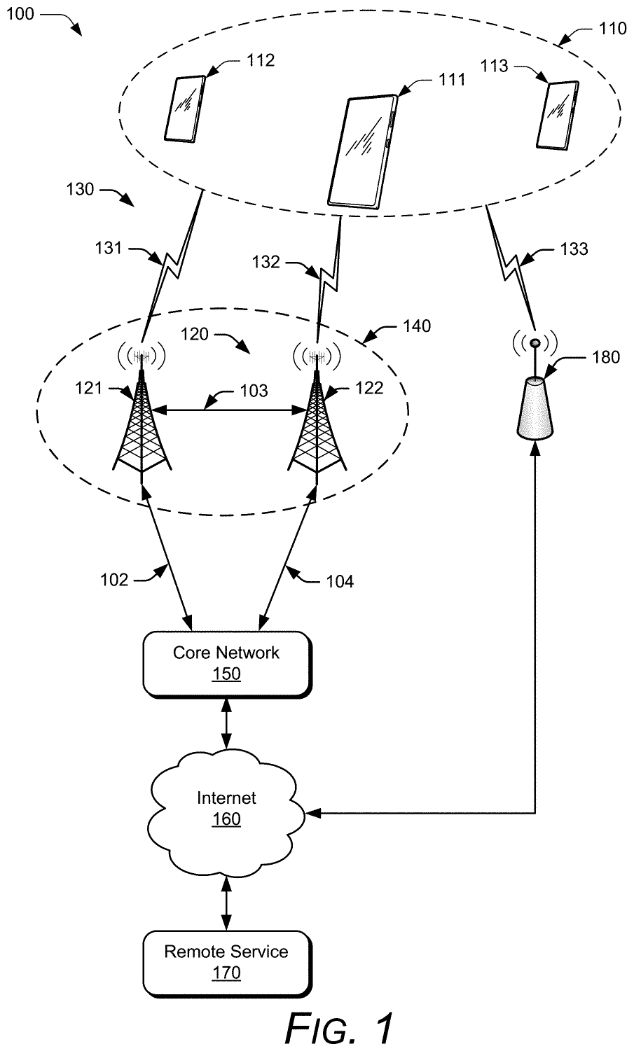

FIG. 1 illustrates an example environment 100 that includes multiple UEs 110, illustrated as UE 111, UE 112, and UE 113. Each UE 110 can communicate with base stations 120 (illustrated as base stations 121 and 122) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., a Next Generation Node B, gNode B, gNB, ng-eNB, or the like) may be implemented in a macrocell, microcell, small cell, picocell, distributed base station, or the like, or any combination or future evolution thereof.

The base stations 120 communicate with the UE 110 using the wireless links 131 and 132, which may be implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 include one or more wireless links (e.g., radio links) or bearers implemented using any suitable communication protocol or standard, or combination of communication protocols or standards, such as 5^{th} Generation New Radio (5G NR). Multiple wireless links 130 can be aggregated using carrier aggregation or multi-connectivity to provide a higher data rate for the UE 110. Multiple wireless links 130 from multiple base stations 120 can be configured for Coordinated Multipoint (CoMP) communication with the UE 110.

The base stations 120 are collectively a Radio Access Network 140 (e.g., RAN, 5G NR RAN, or NR RAN). The base stations 121 and 122 in the RAN 140 are connected to a core network 150. The base stations 121 and 122 connect, at 102 and 104 respectively, to the core network 150 through an NG2 interface for control-plane signaling and through an NG3 interface for user-plane data communications when connecting to a 5G core network. In addition to connections to the core network 150, the base stations 120 can communicate with each other. For example, the base stations 121 and 122 communicate using an Xn Application Protocol (XnAP) through an Xn interface, at 103, to exchange user-plane and control-plane data. The UE 110 connects, through the core network 150, to public networks, such as the Internet 160 to interact with a remote service 170.

The UEs 110 can also connect to the Internet 160 using a WLAN connection 133 to a WLAN access point 180, which is connected to the Internet 160. The WLAN access point 180 may be located in a user's home, an office, an airport, a coffee shop, and so forth. The WLAN access point 180 may be independently operated, such as in a user's home or office, may be part of an enterprise network, or may be operated as part of a public network of WLAN access points operated by a wireless network operator. The WLAN wireless network operator may be the same or different than the operator of the RAN 140.

In the example environment 100, two or more of the UEs 110 use the unlicensed radio spectrum. Sometimes a conflict occurs while, for instance, the UE 111 transmits a first uplink signal to the WLAN access point 180 using a first channel and the UE 112 attempts to transmit a second uplink signal to the base station 121 using the same first channel. Because the first channel is currently occupied by the UE 111, however, the UE 112 is unable to transmit on the first channel without interfering with the UE 111's transmission. Consequently, transmission of the second uplink signal is delayed.

If the conflict continues to occur due to the UE 111 or another UE 110 (e.g., the UE 113) transmitting additional uplink signals using the first channel, the UE 112 may be prevented from performing time-sensitive or periodic procedures. This situation can occur, for instance, when a large quantity of UEs 110 use the unlicensed radio spectrum and are within close proximity to one another. In this case, the first channel is considered to be persistently occupied.

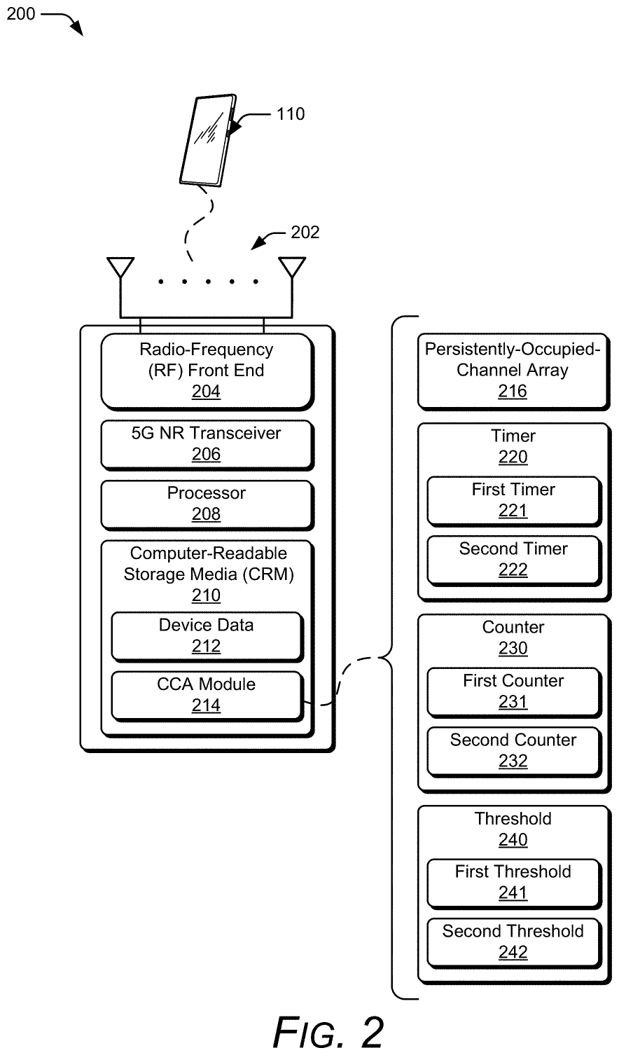

To handle this situation, the UE 112 determines that the first channel is persistently occupied and switches over to using a different channel within the unlicensed radio spectrum. If the UE 112 determines that one or more channels are persistently occupied, the UE 112 executes a recovery procedure to re-establish communication with the base station 120 and report information regarding the persistently occupied channels, as further described below with respect to FIG. 2.

Example Device

FIG. 2 illustrates an example device diagram 200 of the UE 110. The UE 110 can include additional functions and interfaces that are omitted from FIG. 2 for the sake of clarity. In the depicted configuration, the UE 110 includes antennas 202, a radio-frequency (RF) front end 204 (RF front end 204), a radio-frequency transceiver, including, for example, a 5G NR transceiver 206 for communicating with one or more base stations 120 in the RAN 140. The RF front end 204 couples or connects the 5G NR transceiver 206 to the antennas 202 to facilitate various types of wireless communication. The antennas 202 can include an array of multiple antennas that are configured similar to or differently from each other. The antennas 202 and the RF front end 204 are tuned to one or more transmission frequency bands defined by the 5G NR communication standards and implemented by the 5G NR transceiver 206. These transmission frequency bands include those within unlicensed radio spectrum.

The UE 110 also includes one or more processors 208 and memory system including, for example, computer-readable storage media 210 (CRM 210). The processor 208 can be a single core processor or a multiple core processor composed of a variety of materials, such as silicon, polysilicon, high-K dielectric, copper, and so on. The CRM 210 excludes propagating signals and includes any suitable memory or storage device, such as random-access memory (RAM), static RAM (SRAM), dynamic RAM (DRAM), non-volatile RAM (NVRAM), read-only memory (ROM), or Flash memory useable to store device data 212 of the UE 110. The device data 212 includes user data, multimedia data, beamforming codebooks, applications, and/or an operating system of the UE 110, which are executable by the processor 208 to enable user-plane communication, control-plane signaling, and user interaction with the UE 110.

The CRM 210 also includes a clear-channel-assessment (CCA) module 214. Alternatively or additionally, the clear-channel-assessment module 214 can be implemented in whole or part as hardware logic or circuitry integrated with or separate from other components of the UE 110. The clear-channel-assessment module 214 handles detection of and recovery from persistently occupied channels within unlicensed radio spectrum. In particular, the clear-channel-assessment module 214 determines whether or not one or more channels within the unlicensed radio spectrum are persistently occupied. If multiple channels are persistently occupied, the clear-channel-assessment module 214 further executes a recovery procedure that enables the UE 110 to establish communications with a base station 120 and report information regarding the persistently occupied channels.

To determine whether or not a channel is persistently occupied, the clear-channel-assessment module 214 executes a clear-channel-assessment procedure prior to transmitting an uplink signal. In some cases, the clear-channel-assessment procedure is performed as part of a listen-before-talk (LBT) procedure. During the clear-channel-assessment procedure, the clear-channel-assessment module 214 measures an amount of energy that is detected within the channel and compares the detected energy to a threshold. If the detected energy is less than or equal to the threshold, the clear-channel-assessment module 214 determines that the channel is unoccupied and transmits the uplink signal. Alternatively, if the detected energy is above the threshold, the clear-channel-assessment module 214 determines that another device is transmitting on the channel. In other words, the clear-channel-assessment module 214 determines that the channel is occupied. Consequently, the clear-channel-assessment module 214 postpones transmitting on the channel and transmission of the uplink signal is delayed.

In some cases, the clear-channel-assessment module 214 performs a back-off procedure and maintains a back-off or contention timer responsive to determining that the channel is occupied. For subsequent attempts to transmit, the clear-channel-assessment module 214 determines the channel to be occupied until an expiration of the back-off timer.

The CRM 210 additionally stores a persistently-occupied-channel array 216, one or more timers 220 (e.g., a first timer 221 and a second timer 222), one or more counters (e.g., a first counter 231 and a second counter 232), one or more thresholds 240 (e.g., a first threshold 241 and a second threshold 242), or combinations thereof. One or more of these entities are modified and used by the clear-channel-assessment module 214 to determine whether or not the channel is persistently occupied.

Generally speaking, the timer 220 specifies a duration for which the clear-channel-assessment module 214 determines whether or not the channel is persistently occupied. In some implementations, the clear-channel-assessment module 214 also determines that the channel is persistently occupied responsive to the timer 220 expiring. As an example, a duration of the timer 220 is based on a predetermined value that is stored in the CRM 210. In another example, the UE 110 receives a message from a base station 120 that specifies the duration of the timer 220. In either example, the duration of the timer 220 can be based on a first quantity of periodic or predefined uplink transmissions, such as those associated with a random-access (RA) procedure, a sounding reference signal (SRS) procedure, channel-quality-indicator (CQI) reporting, or channel-state-information (CSI) reporting. In other words, the duration of the timer 220 can be greater than or equal to a duration of the random-access procedure, the sounding reference signal procedure, the channel-quality-indicator reporting, or the channel-state-information reporting. In general, the duration of the timer 220 enables the clear-channel-assessment module 214 to evaluate at least a particular quantity of subsequent clear-channel-assessment procedures prior to determining that the channel is persistently occupied.

In various implementations, the clear-channel-assessment module 214 uses one or more counters 230 to count a quantity of clear-channel-assessment procedures that are performed during at least a portion of the duration of the timer 220, a quantity of clear-channel-assessment procedures that determine that the channel is occupied, and/or a quantity of consecutive clear-channel-assessment procedures that determine that the channel is occupied. In some cases, the clear-channel-assessment module 214 compares the counter 230 to an associated threshold 240 to determine whether or not the channel is persistently occupied. In other cases, a comparison of the counter 230 to the threshold 240 triggers a procedure that determines whether or not the channel is persistently occupied. Similar to the duration of the timer 220, a value of the threshold 240 can be stored in the CRM 210 or received from the base station 120. Adjusting the value of the threshold 240 can increase or decrease a likelihood that the clear-channel-assessment module 214 determines that the channel is persistently occupied.

Responsive to determining that the channel is persistently occupied, the clear-channel-assessment module 214 can continually evaluate other channels to identify a channel that is not persistently occupied. If one or more channels are persistently occupied, the clear-channel-assessment module 214 can initiate a radio-link failure procedure or trigger the UE 110 to re-establish a connection with the base station 120.

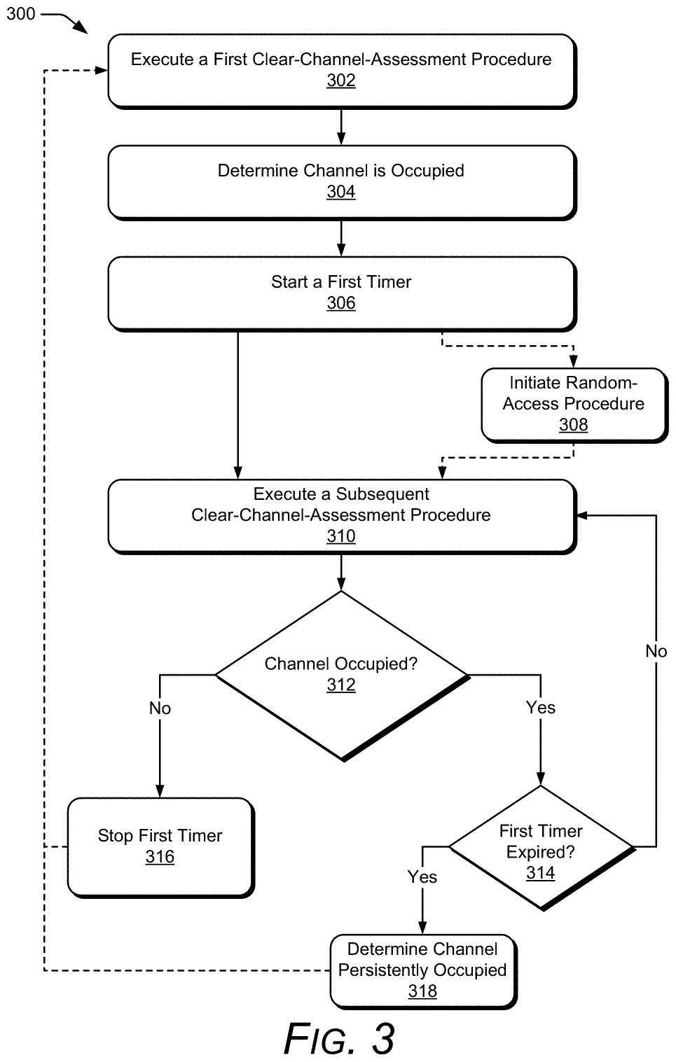

The clear-channel-assessment module 214 uses the persistently-occupied-channel array 216 to keep track of the types of channels that have been evaluated and whether or not the channel is persistently occupied. The persistently-occupied channel array 216 can include, for instance, an array of elements that are associated with different channels, respectively. As an example, the clear-channel-assessment module 214 sets a value of each one of the elements to indicate that the channel has not been evaluated, was evaluated and determined to be persistently occupied, or was evaluated and determined to not be persistently occupied. The clear-channel-assessment module 214 can, at least partially, handle the detection of and recovery from persistently occupied channels within the unlicensed radio spectrum, as described with respect to FIGS. 3-9.

Example Methods for Detecting a Persistently Occupied Channel

FIGS. 3-8 depict example methods 300-800 for detecting a persistently occupied channel within the unlicensed radio spectrum. Methods 300-800 are shown as a set of operations (or acts) performed but not necessarily limited to the order or combinations in which the operations are illustrated. Further, any of one or more of the operations may be repeated, combined, reorganized, skipped, or linked to provide a wide array of additional and/or alternate methods. In portions of the following discussion, reference may be made to environment 100 of FIG. 1 and entities detailed in FIG. 2, reference to which is made for example only. The techniques are not limited to performance by one entity or multiple entities operating on one device.

FIG. 3 illustrates an example method 300 for detecting a persistently occupied channel within the unlicensed radio spectrum using the first timer 221. In the method 300, the UE 110 relies on an expiration of the first timer 221 to determine whether or not a channel is persistently occupied. In particular, the UE 110 determines that the channel is persistently occupied if none of the clear-channel-assessment procedures performed during a duration of the first timer 221 determined that the channel was unoccupied. Responsive to one of the clear-channel-assessment procedures determining that the channel is unoccupied, the UE 110 stops or resets the first timer 221. In this way, the UE 110 avoids determining that the channel is persistently occupied if the channel is unoccupied at least once during the duration of the first timer 221. Relying on the first timer 221 instead of a counter enables the UE 110 to detect instances in which the channel becomes unoccupied, even for short durations, and postpone determining that the channel is persistently occupied. Hence, the clear-channel-assessment procedure is less sensitive to the timing of uplink transmissions by other users of the unlicensed spectrum, and is less sensitive to short-term channel congestion.

At 302, the UE 110 executes a first clear-channel-assessment procedure. For example the UE 110 executes a first clear-channel-assessment procedure for a first channel within the unlicensed radio spectrum before attempting to transmit a first uplink signal.

At 304, the UE determines that the channel is occupied. For example, the UE 110 determines that the first channel is occupied based on a comparison of the detected energy measured within the first channel to a threshold indicating that the detected energy is greater than the threshold, as described above with respect to FIG. 2.

At 306, the UE starts a first timer. For example, the UE 110 starts the first timer 221 of FIG. 2 with a specified duration, as described above with respect to FIG. 2.

Optionally at 308, the UE initiates a random-access procedure. For example, the UE 110 initiates the random-access procedure using the first channel. The random-access procedure provides the UE 110 an opportunity to execute additional clear-channel-assessment procedures for determining whether the first channel is persistently occupied. In this way, the random-access procedure increases reliability for assessing whether the first channel is persistently occupied by enabling the clear-channel-assessment module 214 to evaluate at least a minimum quantity of subsequent clear-channel-assessment procedures prior to determining that the channel is persistently occupied.

At 310, the UE executes a subsequent clear-channel-assessment procedure. For example, the UE 110 executes a second clear-channel-assessment procedure prior to transmitting a second uplink signal. In some cases, the second uplink signal includes a random-access channel (RACH) signal associated with the random-access procedure initiated at 308. In other cases, the second uplink signal includes another type of uplink signal, such as a sounding reference (SR) signal or a physical uplink control channel (PUCCH) signal.

At 312, the UE determines whether or not the channel is occupied based on the subsequent clear-channel-assessment procedure at 310. For example, the UE 110 determines whether or not the first channel is occupied (e.g., busy) based on the second clear-channel-assessment procedure performed at 310. As another example, the UE 110 performs a back-off procedure and determines whether or not the first channel is occupied based on an expiration of a back-off or contention timer. If the UE 110 determines that the first channel is occupied, the operations proceed from 312 to 314. Alternatively, if the UE 110 determines that the first channel is unoccupied, the operations proceed from 312 to 316.

At 316, the UE stops the first timer responsive to the UE determining that the channel is unoccupied at 312. For example, the UE 110 stops the first timer 221 responsive to the UE 110 determining that the first channel is unoccupied based on the second clear-channel-assessment procedure. Additionally, the UE 110 determines that the first channel is not persistently occupied (e.g., the first channel is unoccupied) and updates the persistently-occupied-channel array 216 accordingly. The process can repeat at 302 for a next clear-channel-assessment procedure that evaluates the same channel (e.g., the first channel) or a different channel (e.g., a second channel) that uses a different bandwidth part or a different sub-band of a same bandwidth part.

At 314, the UE determines whether or not the first timer expired. For example, the UE 110 determines whether or not the first timer 221 expired. If the UE 110 determines that the first timer 221 has not expired, the operations proceed from 314 to 310 and the UE 110 continues to execute additional clear-channel-assessment procedures (e.g., a third clear-channel assessment procedure). Alternatively, if the UE 110 determines that the first timer 221 expired, the operations proceed from 314 to 318.

At 318, the UE 110 determines that the channel is persistently occupied. For example, the UE 110 determines that the first channel is persistently occupied and updates the persistently-occupied-channel array 216 accordingly. The process can repeat at 302 for a next clear-channel-assessment procedure that evaluates a different channel.

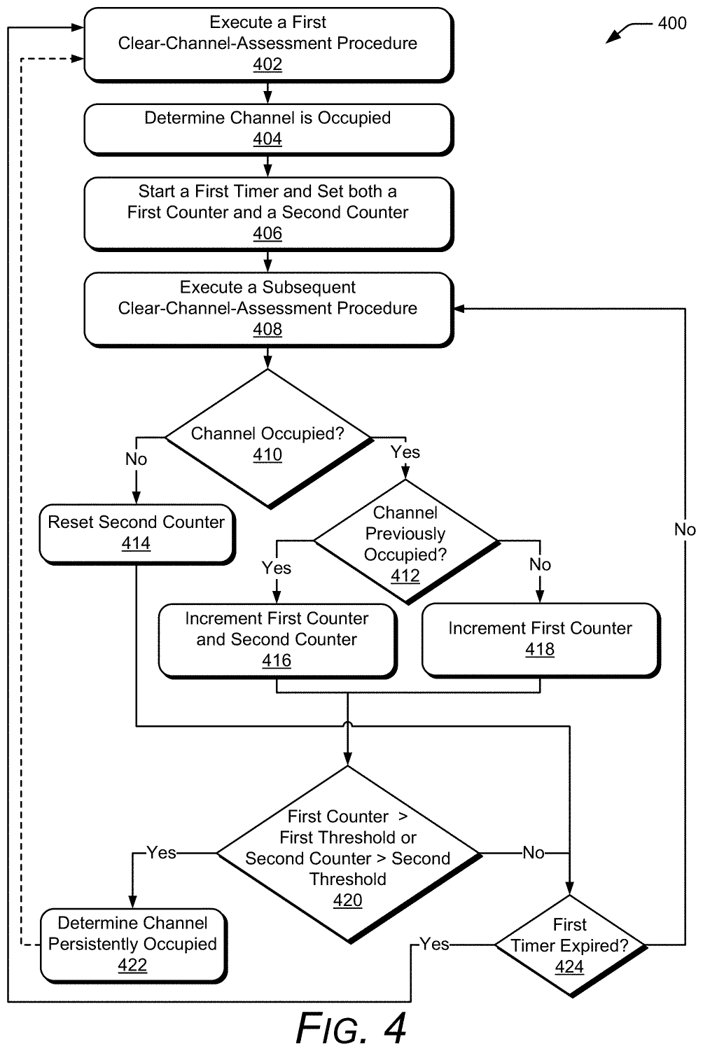

FIG. 4 illustrates an example method 400 for detecting a persistently occupied channel within the unlicensed radio spectrum using the first timer 221, the first counter 231, and the second counter 232. In the method 400, the UE 110 relies on the first counter 231 to count a total quantity of clear-channel-assessment procedures that determine that the channel is occupied within a duration of the first timer 221. The UE 110 also relies on the second counter 232 to count a quantity of consecutive clear-channel-assessment procedures that determine that the channel is occupied within the duration of the first timer 221. The UE 110 determines whether or not the channel is persistently occupied based on the first counter or the second counter 232 exceeding an associated threshold before the first timer 221 expires. This enables the UE 110 to appropriately categorize the channel as persistently occupied even if there is an occasional instance in which the channel is unoccupied. Hence, the clear-channel-assessment procedure is less sensitive to the timing of uplink transmissions by other users of the unlicensed spectrum, and is less sensitive to short-term channel congestion.

At 402 and 404, the UE performs similar operations as described above with respect to FIG. 3 at 302 and 304, respectively. Although not shown, the UE 110 can additionally initiate the random-access procedure, as described above in FIG. 3 at 308.

At 406, the UE starts a first timer and sets (e.g., initializes) both a first counter and a second counter. For example, the UE 110 starts the first timer 221 with a specified duration, as described above with respect to FIG. 2. The UE 110 also sets both the first counter 231 and the second counter 232 equal to a predetermined value, such as zero.

At 408, the UE executes a subsequent clear-channel-assessment procedure, as described above with respect to FIG. 3 at 310.

At 410, the UE determines whether or not the channel is occupied based on the subsequent clear-channel-assessment procedure at 408, as described above with respect to FIG. 3 at 312. If the UE 110 determines that the channel is occupied, the operations proceed from 410 to 412. Alternatively, if the UE 110 determines that the channel is unoccupied, the operations proceed from 410 to 414.

At 414, the UE resets the second counter. For example, the UE 110 resets the second counter 232 equal to zero. The process proceeds to 424.

At 412, the UE determines whether or not the channel was previously occupied based on a previous clear-channel-assessment procedure. For example, the UE 110 determines whether or not the first channel was previously occupied based on a previous clear-channel-assessment procedure. The UE 110 makes this determination based on, for instance, a value of the second counter 232. If the value of the second counter 232 is greater than zero, then the channel was previously determined to be occupied. In contrast, the channel was previously determined to be unoccupied if the value of the second counter 232 is equal to zero. Responsive to the UE 110 determining that the channel was previously occupied, the operations proceed from 412 to 416. Otherwise, the operations proceed from 412 to 418.

At 416, the UE increments both the first counter and the second counter. For example, the UE 110 increments both the first counter 231 and the second counter 232 by one.

At 418, the UE increments the first counter. For example, the UE 110 increments the first counter 231 by one. In this case, a value of the second counter 232 remains unchanged.

At 420, the UE compares the first counter to a first threshold and compares the second counter to a second threshold. For example, the UE 110 compares the first counter 231 to the first threshold 241 and compares the second counter 232 to the second threshold 242. If the first counter 231 is greater than the first threshold 241 or the second counter 232 is greater than the second threshold 242, the operations proceed from 420 to 422. Otherwise, the operations proceed from 420 to 424.

At 422, the UE determines that the channel is persistently occupied, as described above with respect to FIG. 3 at 318. The process can repeat at 402 for a next clear-channel-assessment procedure that evaluates a different channel (e.g., the second channel).

At 424, the UE determines whether or not the first timer expired. For example, the UE 110 determines whether or not the first timer 221 expired. If the first timer 221 has not expired, the operations proceed from 424 to 408. If the first timer 221 expired, the UE 110 determines that the first channel is not persistently occupied (e.g., the first channel is unoccupied) and updates the persistently-occupied-channel array 216 accordingly. The process can repeat at 402 for a next clear-channel-assessment procedure that evaluates the same channel or a different channel.

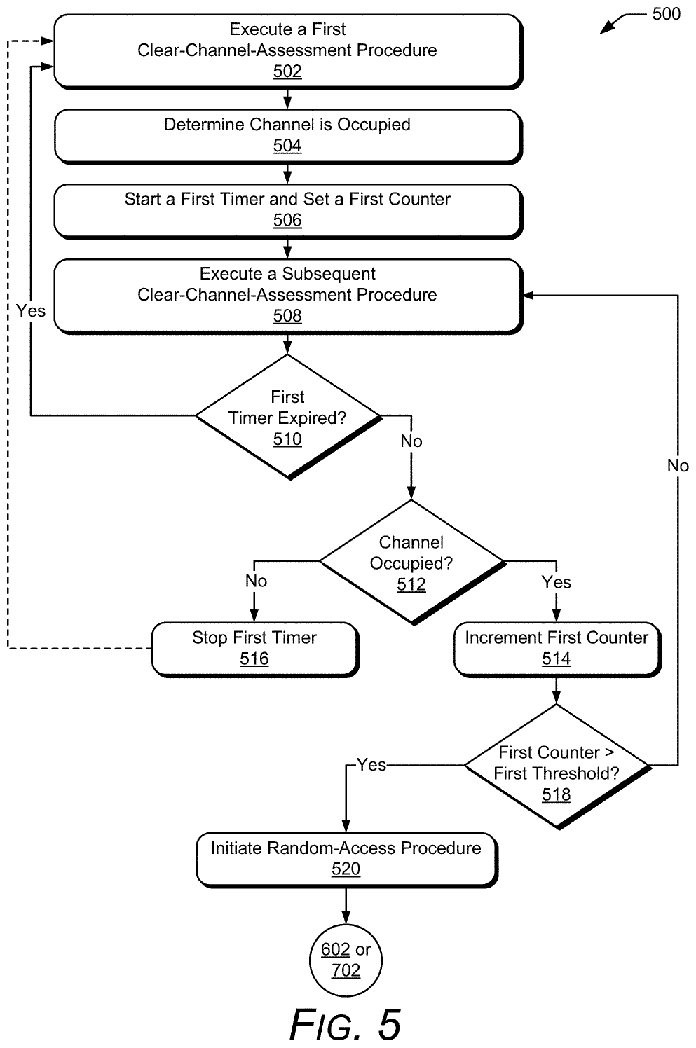

FIG. 5 illustrates an example method 500 for initiating a random-access procedure for detecting a persistently occupied channel within unlicensed radio spectrum using the first timer 221 and the first counter 231. In the method 500, the UE 110 determines that the channel is occupied for a particular duration of time prior to initiating a procedure to determine whether or not the channel is persistently occupied. In this way, the UE 110 avoids incorrectly identifying the channel as persistently occupied for short durations during which the channel is occupied. Hence, the clear-channel-assessment procedure is less sensitive to the timing of uplink transmissions by other users of the unlicensed spectrum, and is less sensitive to short-term channel congestion.

In this example, the UE 110 uses the first counter 231 to count a consecutive quantity of clear-channel assessment procedures that determine that the channel is occupied. If the first counter 231 exceeds the first threshold 241, the UE 110 initiates a random-access procedure.

At 502 and 504, the UE performs similar operations as described above with respect to FIG. 3 at 302 and 304, respectively.

At 506, the UE starts a first timer and sets a first counter. For example, the UE 110 starts the first timer 221 with a specified duration, as described above with respect to FIG. 2. The UE 110 also sets the first counter 231 equal to a predetermined value, such as zero. The first counter 231 counts a quantity of clear-channel-assessment procedures that determine that the first channel is occupied.

At 508, the UE executes a subsequent clear-channel-assessment procedure, as described above with respect to FIG. 3 at 310.

At 510, the UE determines whether or not the first timer expired. For example, the UE 110 determines whether or not the first timer 221 expired. If the first timer 221 has not expired, the operations proceed from 510 to 512. If the first timer 221 expired, the operations proceed from 510 to 502. The process can repeat at 502 for a next clear-channel-assessment procedure that evaluates the same channel (e.g., the first channel) or a different channel (e.g., the second channel).

At 512, the UE determines whether or not the channel is occupied based on the subsequent clear-channel-assessment procedure, as described above with respect to FIG. 3 at 312. If the UE 110 determines that the first channel is occupied, the operations proceed from 512 to 514. Alternatively, if the UE 110 determines that the channel is unoccupied, the operations proceed from 512 to 516.

At 516, the UE stops the first timer. For example, the UE 110 stops the first timer 221. Additionally, the UE 110 determines that the first channel is not persistently occupied (e.g., the first channel is unoccupied) and updates the persistently-occupied-channel array 216 accordingly. The process can repeat at 502 for a next clear-channel-assessment procedure that evaluates the same channel (e.g., the first channel) or a different channel (e.g., a second channel).

At 514, the UE increments the first counter. For example, the UE 110 increments the first counter 231 by one. Due to the stopping of the first timer 221 at 516 and the transition from 516 to 502 responsive to the UE 110 determining the channel is unoccupied, the first counter 231 maintains a count of a quantity of consecutive clear-channel-assessment procedures that determine that the channel is occupied.

At 518, the UE compares the first counter to a first threshold. For example, the UE 110 compares the first counter 231 to the first threshold 241. If the first counter 231 is greater than the first threshold 241, the operations proceed from 518 to 520 to initiation a procedure that determines whether or not the first channel is persistently occupied. Otherwise, the operations proceed from 518 to 508.

At 520, the UE initiates a random-access procedure, as described above with respect to FIG. 3 at 308. The random-access procedure provides the UE 110 opportunities to execute additional clear-channel-assessment procedures for determining whether the first channel is persistently occupied. During 520, the base station 120 broadcasts a random-access preamble to the UE 110 using a system information message. The UE 110 uses the preamble to perform the random-access procedure.

The UE 110 can perform the random-access procedure with a primary cell (PCell) or a secondary cell (SCell). As an example, the UE 110 performs the two-step random-access procedure or the four-step random-access procedure with the PCell if the channel is associated with a special cell (SpCell) (e.g., the PCell of a master cell group (MCG) or a primary SCell of a secondary cell group (SCG)).

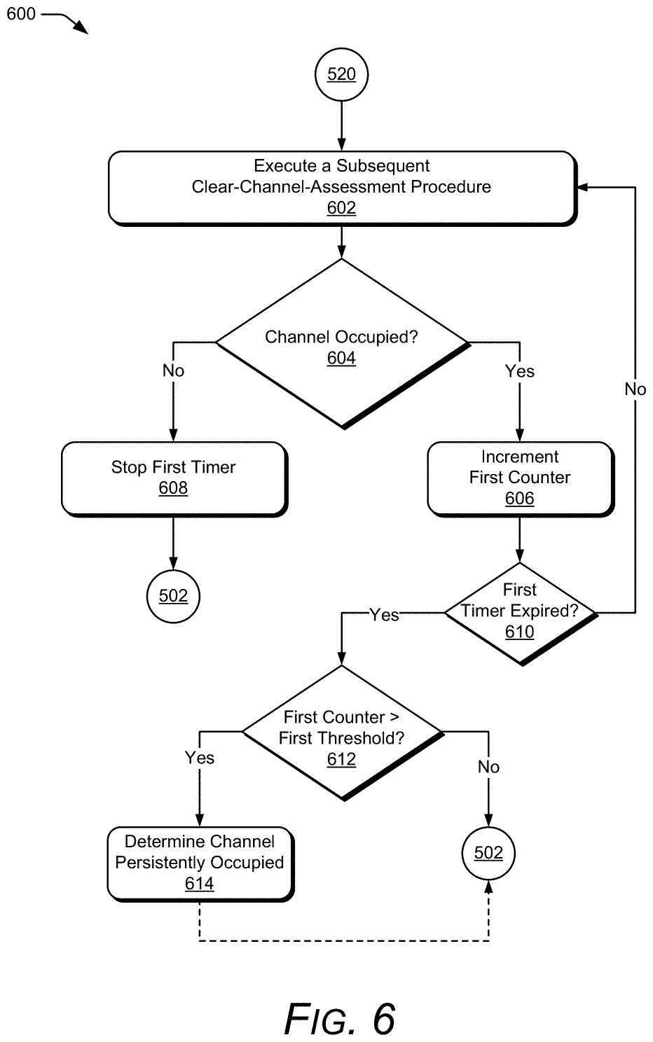

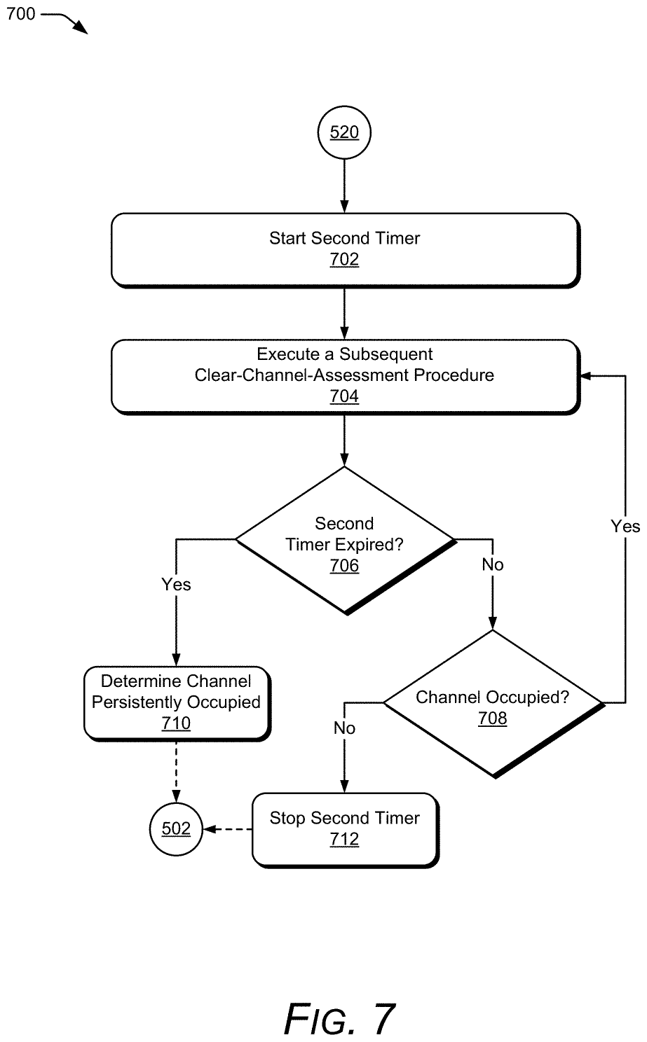

In another example, the UE 110 performs the two-step random-access procedure with the SCell if the channel is associated with the SCell. The SCell configures and broadcasts a preamble index for the UE 110 to perform the two-step random-access procedure. In some cases, the SCell configures the physical-random-access channel (PRACH) for the UE 110 to transmit the preamble for the random-access procedure. The operations proceed from 520 to either 602 of FIG. 6 or 702 of FIG. 7, which are further described below.

FIG. 6 illustrates an example method 600 for detecting a persistently occupied channel within the unlicensed radio spectrum using a random-access procedure, the first timer 221, and the first counter 231. This method describes additional operations that are performed responsive to the initialization of the random-access procedure at 520 of FIG. 5.

At 602, the UE sets a first counter. For example, the UE 110 sets the first counter 231 equal to a predetermined value, such as zero. Although shown as occurring after 520, the operation at 602 can alternatively occur before or as part of the operation at 520.

At 602, the UE executes a subsequent clear-channel-assessment procedure, as described above with respect to FIG. 3 at 310.

At 604, the UE determines whether or not the channel is occupied. If the channel is occupied, the operations proceed from 604 to 606. Otherwise, the operations proceed from 604 to 608.

At 608, the UE stops the first timer 221. For example, the UE 110 stops the first timer 221. Additionally or alternatively, the UE 110 resets the first counter 231. The UE 110 also determines that the first channel is not persistently occupied (e.g., the first channel is unoccupied) and updates the persistently-occupied-channel array 216 accordingly. The process can repeat at 502 for the same channel or a different channel.

At 606, the UE increments the first counter responsive to determining that the channel is occupied at 604. For example, the UE increments the first counter 231 by one. Due to the stopping of the first timer 221 at 608 and the transition from 608 to 502 responsive to the UE 110 determining the channel is unoccupied, the first counter 231 maintains a count of a quantity of consecutive clear-channel-assessment procedures that determine that the channel. This count includes the subsequent clear-channel-assessment procedures 508 performed at 508 and evaluated at 512 prior to the initiation of the random-access procedure at 520.

At 610, the UE determines whether or not the first timer expired. For example, the UE 110 determines whether or not the first timer 221 expired. If the first timer 221 has not expired, the operations proceed from 610 to 602. Alternatively, if the first timer 221 expired, the operations proceed from 610 to 612.

At 612, the UE compares the first counter to a first threshold. For example, the UE 110 compares the first counter 231 to the first threshold 241. The first threshold 241 at 612 can be similar to or different from the first threshold 241 at 518. If the first counter 231 is greater than the first threshold 241, the operations proceed from 612 to 614. Otherwise, the UE 110 determines that the first channel is not persistently occupied (e.g., the first channel is unoccupied) and updates the persistently-occupied-channel array 216 accordingly. The process can then repeat at 502 for the same channel or a different channel.

At 614, the UE determines that the channel is persistently occupied, as described above with respect to FIG. 3 at 318. The process can repeat at 502 for a next clear-channel-assessment procedure that evaluates a different channel.

FIG. 7 illustrates an example method 700 for detecting a persistently occupied channel using a random-access procedure, the first timer 221, and a second timer 222. This method describes additional operations that are performed responsive to the initialization of the random-access procedure at 520 of FIG. 5. Instead of maintaining and comparing the first counter 231 to the first threshold 241, as described above with respect to FIG. 6, the method of FIG. 7 detects an expiration of the second timer 222 to determine that the channel is persistently occupied. Similar to the first counter 231 in FIG. 6, the second timer 222 enables the UE 110 to recognize that consecutive clear-channel-assessment procedures determine that the channel is occupied.

At 702, the UE starts a second timer. For example, the UE 110 starts the second timer 222 with a specified duration, as described above with respect to FIG. 2. A duration of the second timer 222 can be similar to or different from the duration of the first timer 221.

At 704, the UE executes a subsequent clear-channel-assessment procedure, as described above with respect to FIG. 3 at 310.

At 706, the UE determines whether or not the second timer expired. For example, the UE 110 determine whether or not the second timer 222 expired. If the second timer 222 expired, the operations proceed from 706 to 710. Otherwise, the operations proceed from 706 to 708.

At 710, the UE determines that the channel is persistently occupied, as described above with respect FIG. 3 at 318. The process can repeat at 502 for a next clear-channel-assessment procedure that evaluates a different channel.

At 708, the UE determines whether or not the channel is occupied responsive to the second timer not expiring. If the channel is occupied, the operations proceed from 708 to 704. Otherwise, the operations proceed from 708 to 712.

At 712, the UE stops the second timer. For example, the UE 110 stops the second timer 222, and the operations proceed from 712 to 502. The UE 110 additionally determines that the first channel is not persistently occupied (e.g., the first channel is unoccupied) and updates the persistently-occupied-channel array 216 responsive to stopping the second timer 222 at 712.

In another implementation not shown, the operations described above at 702, 706, and 712 can apply to the first timer 221 instead of the second timer 222. In this way, the first timer 221 can be re-used for determining whether or not the first channel is persistently occupied.

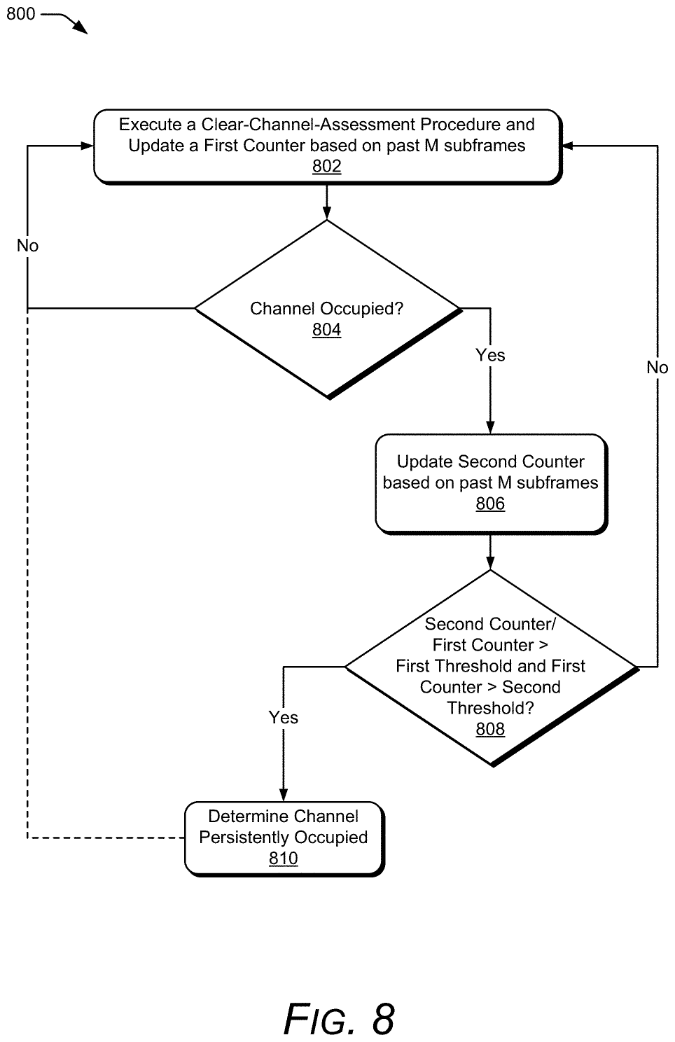

FIG. 8 illustrates another example method 800 for detecting a persistently occupied channel within the unlicensed radio spectrum using a window-based detection scheme. In this example, the UE 110 uses the first counter 231, the second counter 232, the first threshold 241, and the second threshold 242. The first counter 231 represents a total quantity of clear-channel-assessment procedures performed within the past M subframes, where M is a positive integer. The second counter 232 represents a total quantity of clear-channel-assessment procedures that determine that the channel is occupied within the past M subframes. In some implementations, the first counter 231 and the second counter 232 include an array of values that are specific to each channel so that the counters 231 and 232 can be appropriately updated if the UE 110 switches between different types of channels.

The UE 110 determines whether or not the channel is persistently occupied based on a ratio of the second counter 232 and the first counter 231 exceeding the first threshold 241, and based on the first counter 231 exceeding the second threshold 242. In this way, the UE 110 uses recent information (e.g., information from the last M subframes) to make this determination and considers both the quantity of clear-channel-assessment procedures performed and the percentage of time the channel was occupied within a moving window of time.

At 802, the UE executes a clear-channel-assessment procedure and updates a first counter based on the past M subframes. For example, the UE 110 executes a first clear-channel-assessment procedure and updates the first counter 231 based on the past M subframes. Although not shown, the UE 110 can additionally initiate the random-access procedure, as described above in FIG. 3 at 308.

At 804, the UE determines whether or not the channel is occupied, as described above with respect to FIG. 3 at 304. If the channel is occupied, the operations proceed from 804 to 806. Otherwise, the operations proceed from 804 to 802.

At 806, the UE updates a second counter based on the past M subframes. For example, the UE 110 updates the second counter 232 based on the past M subframes. In a particular instance, the UE 110 increments the second counter 232 to account for the channel being occupied at 804 and to account for the channel not being occupied during the past M+1 subframe. In another instance, the UE 110 does not change the second counter 232 to account for the channel being occupied at 804 and to account for the channel being occupied during the past M+1 subframe. In this case, the second counter 232 remains the same.

At 808, the UE compares a ratio of the second counter and the first counter to a first threshold and compares the first counter to a second threshold. For example, the UE 110 compares the ratio of the second counter 232 and the first counter 231 to the first threshold 241. The UE 110 also compares the first counter 231 to the second threshold 242. If the ratio is greater than the first threshold 241 and the first counter 231 is greater than the second threshold 242, the operations proceed from 808 to 810. Otherwise, the operations proceed from 808 to 802 and the UE 110 determines that the first channel is not persistently occupied (e.g., the first channel is unoccupied) and updates the persistently-occupied-channel array 216 accordingly.

At 810, the UE determines that the channel is persistently occupied, as described above with respect to FIG. 3 at 318. The process can repeat at 802 for a next clear-channel-assessment procedure that evaluates a different channel.

Example Methods for Recovering from Multiple Persistently Occupied Channels

As described above, the methods of 300-800 can repeat such that the UE 110 determines whether or not channels that are associated with different bandwidth parts or different sub-bands within a particular bandwidth part are persistently occupied.

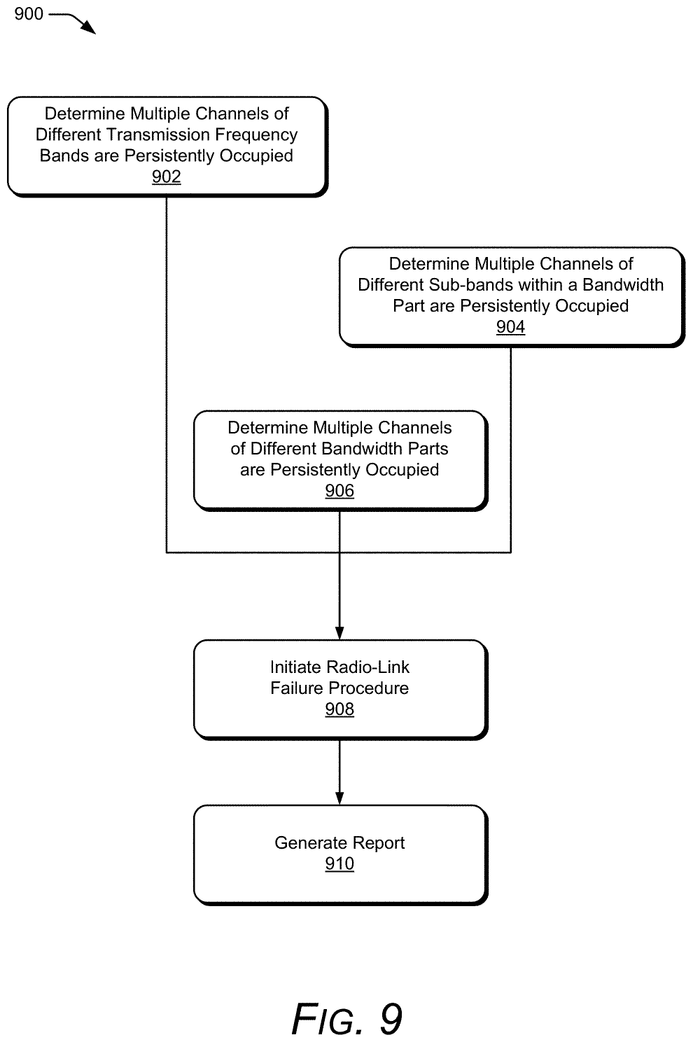

FIG. 9 depicts an example method 900 for recovering from multiple persistently occupied channels. Method 900 is shown as a set of operations (or acts) performed but not necessarily limited to the order or combinations in which the operations are illustrated. Further, any of one or more of the operations may be repeated, combined, reorganized, skipped, or linked to provide a wide array of additional and/or alternate methods. In portions of the following discussion, reference may be made to environment 100 of FIG. 1 and entities detailed in FIG. 2, reference to which is made for example only. The techniques are not limited to performance by one entity or multiple entities operating on one device.

At 902, the UE determines that multiple channels associated with different transmission frequency bands are persistently occupied. For example, the UE 110 determines that a first channel associated with a first transmission frequency band and a second channel associated with a second transmission frequency band are both persistently occupied. The first transmission frequency band and the second transmission frequency band can be associated with different bandwidth parts, different sub-bands of a same bandwidth part, different sub-bands associated with different bandwidth parts, or a combination thereof.

Alternatively, at 904, the UE uses a set of sub-bands associated with a particular bandwidth part and determines that the multiple channels associated with each sub-band within the set of sub-bands are persistently occupied. For example, the UE 110 determines that a first channel associated with a first sub-band of a bandwidth part and a second channel associated with a second sub-band of the bandwidth part are both persistently occupied. In some cases, this can occur responsive to all channels associated with each of the sub-bands within the bandwidth part determined to be persistently occupied.

Alternatively, at 906, the UE uses a set of bandwidth parts and determines that the multiple channels associated with each bandwidth part within the set of bandwidth parts are persistently occupied. For example, the UE 110 determines that a first channel associated with a first bandwidth part and a second channel associated with a second bandwidth part are both persistently occupied.

At 908, the UE initiates a radio-link failure procedure based on the occurrence of 902, 904, or 906. For example, the UE 110 initiates the radio-link failure procedure responsive to either the operations at 902 occurring for a configured bandwidth part of a PCell, the operations at 904 occurring for the PCell, or the operations at 906 occurring for a MCG. The radio-link failure procedure causes the UE 110 to attempt to re-establish communication with the base station 120.

Additionally or alternatively, the UE generates a report at 910. For example, the UE 110 generates the report, which can include information regarding any of the parameters used to determine that the multiple channels are persistently occupied (e.g., values of respective first timers 221, respective second timers 222, respective first counters 231, respective second counters 232, respective first thresholds 241, and/or respective second thresholds 242), the types of uplink transmissions (e.g., SR, PUCCH, or RACH) that occurred, the types of clear-channel-assessment procedures (e.g., a type1 listen-before talk or a type 2 listen-before talk), the type of channel access priority class (CAPC), and so forth.

Consider an example in which the UE 110 uses carrier aggregation. Responsive to 902 or 904 occurring for a SCell, the UE either sends the report to the SCell using a different bandwidth part that is not persistently occupied (e.g., based on the persistently-occupied-channel array 216) or sends the report to the PCell. Responsive to receiving the report, the PCell releases the SCell.

Consider another example in which the UE 110 is configured with multi-node connectivity (e.g., dual connectivity). Responsive to 902, 904, or 906 occurring for the PCell in the SCG (e.g., the PsCell), the UE 110 sends the report to the PCell. In this case, the report represents an extended SCG failure report. The report can additionally include information associated with the availability of other SCells within the SCG. Responsive to receiving the report, the PCell releases the secondary cell group (SCG) or configures a different SCG. In the examples described above, the PCell and the SCell can use the licensed radio spectrum, the unlicensed radio spectrum, or a combination thereof.

Example Method for Handling a Persistently Occupied Channel

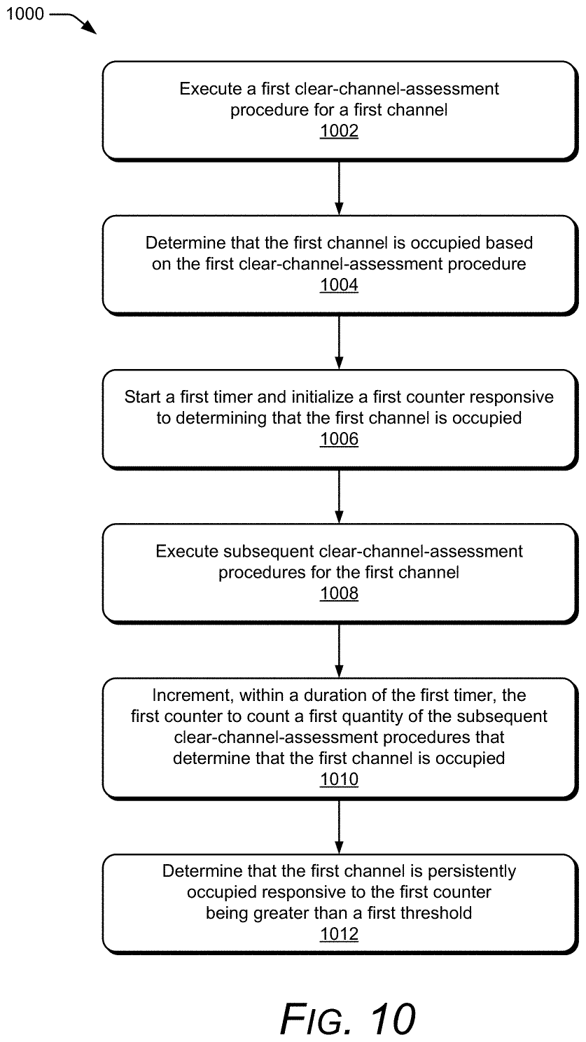

FIG. 10 depicts an example method 1000 for handling a persistently occupied channel. Method 1000 is shown as a set of operations (or acts) performed but not necessarily limited to the order or combinations in which the operations are illustrated. Further, any of one or more of the operations may be repeated, combined, reorganized, skipped, or linked to provide a wide array of additional and/or alternate methods. In portions of the following discussion, reference may be made to environment 100 of FIG. 1 and entities detailed in FIG. 2, reference to which is made for example only. The techniques are not limited to performance by one entity or multiple entities operating on one device.

At 1002, a wireless transmitting device executes a first clear-channel-assessment procedure for a first channel. For example, the user equipment 110 executes the first clear-channel-assessment procedure, as shown at 302 in FIG. 3, at 402 in FIG. 4, or at 502 in FIG. 5. The first channel is associated with the unlicensed radio spectrum.

At 1004, the wireless transmitting device determines that the first channel is occupied based on the first clear-channel-assessment procedure. For example, the UE 110 determines that the first channel is occupied based on the first clear-channel-assessment procedure, as shown at 304 in FIG. 3, at 404 in FIG. 4, or at 504 in FIG. 5.

At 1006, the wireless transmitting device starts a first timer and initializes a first counter responsive to determining that the first channel is occupied. For example, the UE 110 starts a timer 220 (e.g., the first timer 221 of FIG. 2) and initializes a counter 230 (e.g., the first counter 231 or the second counter 232 of FIG. 2) responsive to determining that the first channel is occupied at 1004. For example, the UE 110 can start the first timer 221 responsive to determining that the first channel is occupied, as shown at 306 in FIG. 3, at 406 in FIG. 4, or at 506 in FIG. 5. Additionally, the UE 110 can initialize the first counter 231 and/or the second counter 232 responsive to determining that the first channel is occupied, as shown at 406 in FIG. 4, or at 506 in FIG. 5.

The timer 220 can specify a duration for which the UE 110 determines whether or not the first channel is persistently occupied. In some implementations, an expiration of the timer 220 can indicate that the channel is persistently occupied, as shown at 318 in FIG. 3 and at 424 in FIG. 4. In some cases, a duration of the timer 220 is associated with a duration of at least one of the following operations: a random-access procedure, a sounding reference signal procedure, channel-quality-indicator reporting, or channel-state-information reporting.

The counter 230 can count a total quantity or a consecutive quantity of clear-channel-assessment procedures that determine that the first channel is occupied. In some cases, the UE 110 uses the counter 230 to determine whether or not the first channel is persistently occupied.

At 1008, the wireless transmitting device executes subsequent clear-channel-assessment procedures for the first channel. For example, the UE 110 executes subsequent clear-channel-assessment procedures for the first channel, as shown at 310 in FIG. 3, at 408 in FIG. 4, at 508 in FIG. 5, at 602 in FIG. 6, at 704 in FIG. 7, and at 802 in FIG. 8. In some situations, these subsequent clear-channel-assessment procedures occur after a random-access procedure is initiated, as shown at 308 in FIG. 3 and at 520 in FIG. 5.

At 1010, the wireless transmitting device increments the first counter within a duration of the first timer to count a first quantity of the subsequent clear-channel-assessment procedures that determine that the first channel is occupied. For example, the UE 110 increments, within a duration of the timer 220, the counter 230 to count a quantity of the subsequent clear-channel-assessment procedures that determine that the first channel is occupied. In an example implementation, the UE 110 increments the first counter 231 while the first timer 221 is active (e.g., has not expired) to count the total quantity of the subsequent clear-channel-assessment procedures that determine that the first channel is occupied, as shown at 418 in FIG. 4 and at 514 in FIG. 5. In another example implementation, the UE 110 increments the first counter 231 while the first timer 221 is active to count a quantity of consecutive subsequent clear-channel-assessment procedures that determine that the first channel is occupied, as shown at 606 in FIG. 6.

At 1012, the wireless transmitting device determines the first channel to be persistently occupied responsive to the first counter being greater than a first threshold. For example, the UE 110 determines that the first channel is persistently occupied responsive to the counter 230 being greater than a threshold 240 (e.g., the first threshold 241 or the second threshold 242 of FIG. 2). In an example implementation, the first counter 231 is compared to the first threshold 241 at 420 in FIG. 4 and at 612 in FIG. 6. If the first counter 231 is greater than the first threshold 241, the UE 110 determines the first channel is occupied, as shown at 422 in FIG. 4 and at 614 in FIG. 6.

Alternatively, the UE 110 can initiate a procedure that determines whether or not the first channel is persistently occupied responsive to the first counter 231 being greater than the first threshold 221. As an example, the UE 110 can perform the operations starting at 520 in FIG. 5. In FIG. 6, these operations further rely on the first timer 221 and the first counter 231 to determine whether or not the first channel is persistently occupied. In FIG. 7, these operations rely on the second timer 222 to determine whether or not the first channels is persistently occupied.

Although the method 1000 is described with respect to a first channel, these operations can be repeated for evaluating other channels within the unlicensed radio spectrum. If the UE 110 determines that multiple channels are persistently occupied, the UE 110 can recover from the situation by initiating a radio-link failure procedure 908, as shown in FIG. 9. In general, any combination of the operations described in the methods 300-1000 can be integrated together or executed in parallel to enable the UE 110 to handle persistently occupied channels within the unlicensed radio spectrum.

### CONCLUSION

Although techniques for handling persistently occupied channels within unlicensed radio spectrum have been described in language specific to features and/or methods, it is to be understood that the subject of the appended claims is not necessarily limited to the specific features or methods described. Rather, the specific features and methods are disclosed as example implementations of handling persistently occupied channels within unlicensed radio spectrum.

Some examples are described below.

### Example 1

A method for a user equipment comprising:

executing a first clear-channel-assessment procedure for a first channel;

determining that the first channel is occupied based on the first clear-channel-assessment procedure;

starting a first timer and initializing a first counter responsive to determining that the first channel is occupied;

executing subsequent clear-channel-assessment procedures for the first channel;

incrementing, within a duration of the first timer, the first counter to count a first quantity of the subsequent clear-channel-assessment procedures that determine that the first channel is occupied; and

determining that the first channel is persistently occupied responsive to the first counter being greater than a first threshold.

### Example 2

The method of example 1, wherein the first channel is within unlicensed radio spectrum.

### Example 3

The method of example 1 or 2, further comprising: determining that the first channel is persistently occupied responsive to the first timer expiring.

### Example 4

The method of any preceding example, further comprising:

determining that the first channel is unoccupied according to one of the subsequent clear-channel-assessment procedures; and

responsive to determining that the first channel is unoccupied, stopping the first timer and determining that the first channel is not persistently occupied.

### Example 5

The method of any preceding example, further comprising: initiating a radio-link failure procedure responsive to determining that the first channel is persistently occupied.

### Example 6

The method of example 5, further comprising:

determining that a second channel is persistently occupied; and

initiating the radio-link failure procedure responsive to determining that both the first channel and the second channel are persistently occupied.

### Example 7

The method of example 6, wherein the first channel and the second channel are associated with:

different bandwidth parts; or

different sub-bands of a same bandwidth part.

### Example 8

The method of any of examples 5-7, further comprising:

responsive to initiating the radio-link failure procedure, generating a report comprising at least one of the following:

a value of the first counter;

a value of the first threshold; or

a value of the first timer.

### Example 9

The method of any preceding example, further comprising:

initializing a second counter responsive to determining that the first channel is occupied based on the first clear-channel-assessment procedure;

incrementing, within the duration of the first timer, the second counter to count a second quantity of subsequent clear-channel assessment procedures that consecutively determine that the first channel is occupied; and

determining that the first channel is persistently occupied responsive to the second counter being greater than a second threshold.

### Example 10

The method of example 9, further comprising:

determining that the first channel is not persistently occupied responsive to the first timer expiring, the first counter being less than the first threshold, and the second counter being less than the second threshold.

### Example 11

The method of any preceding example, wherein a duration of the first timer is associated with a duration of at least one of the following operations:

a random-access procedure;

a sounding reference signal procedure;

channel-quality-indicator reporting; or

channel-state-information reporting.

### Example 12

The method of any preceding example, further comprising:

initiating a random-access procedure responsive to the first counter being greater than the first threshold.

### Example 13

The method of any preceding example, further comprising:

updating a third counter to represent a total quantity of the subsequent clear-channel-assessment procedures executed within a particular quantity of subframes;

comparing a ratio of the first counter and the third counter to a third threshold; and

determining that the first channel is persistently occupied responsive to the ratio being greater than the third threshold and the first counter being greater than the first threshold.

### Example 14

The method of any preceding example, further comprising:

maintaining a persistently-occupied-channel array comprising elements associated with different channels, wherein:

the different channels include the first channel; and

a value of each element within the persistently-occupied-channel array indicates whether or not a corresponding channel of the different channels is persistently occupied or unoccupied.

### Example 15

A user equipment comprising:

a radio-frequency transceiver; and

a processor and memory system configured to perform the method of any of examples 1-14.

### Example 16

The user equipment of example 15, wherein the user equipment is configured to:

initiate a radio-link failure procedure responsive to determining that a channel is persistently occupied.

### Example 17

A processor-readable medium having instructions stored thereon that, when executed by a processor, cause the processor to perform the method of any of examples 1-11.

### Example 18

The processor-readable medium of example 17, wherein the instructions, when executed by the processor, cause the processor to:

initiate a radio-link failure procedure responsive to determining that a channel is persistently occupied.

What is claimed is:

1. A method for a user equipment comprising:
executing a first clear-channel-assessment procedure for a first channel;
determining that the first channel is occupied based on the first clear-channel-assessment procedure;
starting a first timer and initializing a first counter responsive to determining that the first channel is occupied;
executing subsequent clear-channel-assessment procedures for the first channel;
incrementing, within a duration of the first timer, the first counter to count a first quantity of the subsequent clear-channel-assessment procedures that determine that the first channel is occupied; and
determining that the first channel is persistently occupied responsive to the first counter being greater than a first threshold.

2. The method of claim 1, wherein the first channel is within unlicensed radio spectrum.

3. The method of claim 1, further comprising:
determining that the first channel is persistently occupied responsive to the first timer expiring.

4. The method of claim 1, further comprising:
determining that the first channel is unoccupied according to one of the subsequent clear-channel-assessment procedures; and
responsive to determining that the first channel is unoccupied, stopping the first timer and determining that the first channel is not persistently occupied.

5. The method of claim 1, further comprising:
initiating a radio-link failure procedure responsive to determining that the first channel is persistently occupied.

6. The method of claim 5, further comprising:
determining that a second channel is persistently occupied; and
initiating the radio-link failure procedure responsive to determining that both the first channel and the second channel are persistently occupied.

7. The method of claim 6, wherein the first channel and the second channel are associated with:
different bandwidth parts; or
different sub-bands of a same bandwidth part.

8. The method of claim 5, further comprising:
responsive to initiating the radio-link failure procedure, generating a report comprising at least one of the following:
a value of the first counter;
a value of the first threshold; or
a value of the first timer.

9. The method of claim 1, wherein a duration of the first timer is associated with a duration of at least one of the following operations:
a random-access procedure;
a sounding reference signal procedure;
channel-quality-indicator reporting; or
channel-state-information reporting.

10. The method of claim 1, further comprising:
initiating a random-access procedure responsive to the first counter being greater than the first threshold.

11. The method of claim 1, further comprising:
maintaining a persistently-occupied-channel array comprising elements associated with different channels, wherein:
the different channels include the first channel; and
a value of each element within the persistently-occupied-channel array indicates whether or not a corresponding channel of the different channels is persistently occupied or unoccupied.

12. A user equipment configured to:
execute a first clear-channel-assessment procedure for a first channel;
determine that the first channel is occupied based on the first clear channel assessment procedure;
start a first timer and initialize a first counter responsive to determining that the first channel is occupied;
execute subsequent clear-channel-assessment procedures for the first channel;
increment, within a duration of the first timer, the first counter to count a first quantity of the subsequent clear channel assessment procedures that determine that the first channel is occupied; and
determine that the first channel is persistently occupied responsive to the first counter being greater than a first threshold.

13. The user equipment of claim 14, wherein the first channel is within unlicensed radio spectrum.

14. The user equipment of claim 14, wherein the user equipment is configured to determine that the first channel is persistently occupied responsive to the first timer expiring.

15. The user equipment of claim 14, wherein the user equipment is configured to:
determine that the first channel is unoccupied according to one of the subsequent clear-channel-assessment procedures; and
responsive to determining that the first channel is unoccupied, stop the first timer and determine that the first channel is not persistently occupied.

16. The user equipment of claim 12, wherein the user equipment is configured to:
initiate a radio-link failure procedure responsive to determining that the first channel is persistently occupied.

17. A processor-readable medium having instructions stored thereon that, when executed by a processor, cause the processor to:
execute a first clear-channel-assessment procedure for a first channel;
determine that the first channel is occupied based on the first clear channel assessment procedure;
start a first timer and initialize a first counter responsive to determining that the first channel is occupied;
execute subsequent clear-channel-assessment procedures for the first channel;
increment, within a duration of the first timer, the first counter to count a first quantity of the subsequent clear channel assessment procedures that determine that the first channel is occupied; and
determine that the first channel is persistently occupied responsive to the first counter being greater than a first threshold.

18. The processor-readable medium of claim 17, wherein the first channel is within unlicensed radio spectrum.

19. The processor-readable medium of claim 17, wherein the instructions, when executed by the processor, cause the processor to determine that the first channel is persistently occupied responsive to the first timer expiring.

20. The processor-readable medium of claim 17, wherein the instructions, when executed by the processor, cause the processor to initiate a radio-link failure procedure responsive to determining that the first channel is persistently occupied.
